(19) United States
(12) Patent Application Publication
(10) Pub. No.: US 2009/0078211 A1
(43) Pub. Date: Mar. 26, 2009

(54) Hummingbird feeder with flying insect control

(76) Inventor: Thomas Charlton, Lima, OH (US)

Correspondence Address: Thomas Charlton, 782 Kiowa Trail, Lima, OH, 45805, US

(21) Appl. No.: 11/903,576

(22) Filed: Sep. 25, 2007

(51) Int. Cl. A01K 39/026

(52) U.S. Cl. 119/77

(57) ABSTRACT

This invention entails the re-design of existing hummingbird feeders that have an upper nectar reservoir with mating base holding the lower nectar reservoir. Please refer to Drawing SKETCH 12006 This is a re-designed hummingbird feeder that lowers the base nectar level approximately one fourth inch (¼″) and out of reach of flying insects, thus eliminating their presence and removing the nuisance and the possibility of painful stings to people. This is a re-designed hummingbird feeder that eliminates the presence of flying insects and their robbing of nectar, thus reducing the expense of nectar.

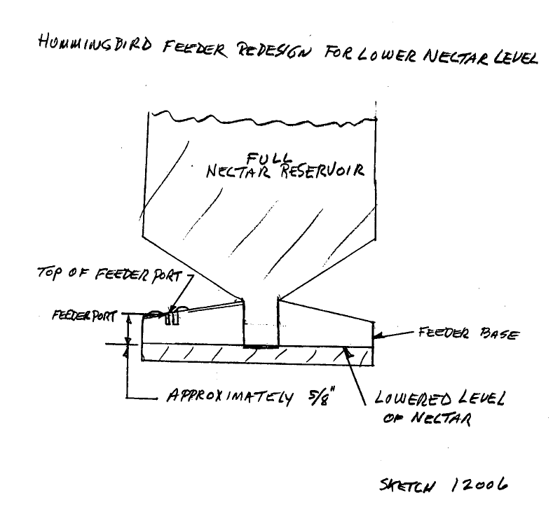

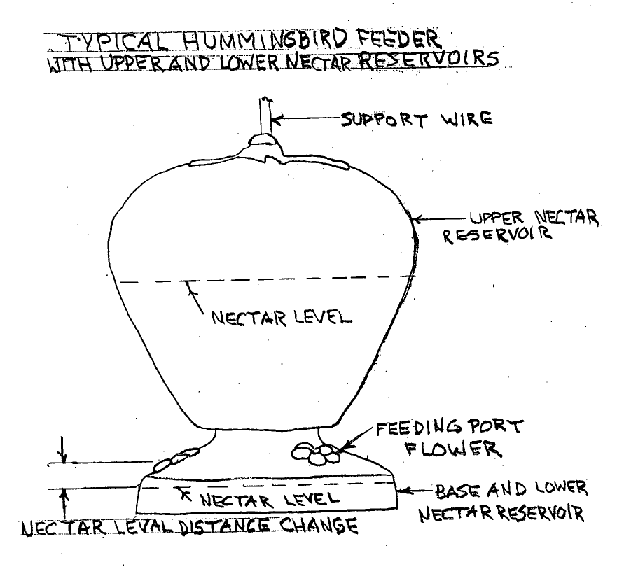

### SPECIFICATION/DESCRIPTION

The re-designed hummingbird feeder is a design that has a reservoir for nectar mounted above the base that contains the lower nectar reservoir. The nectar level in the base is fixed by the base design. The top reservoir is an inverted container similar to a bottle that when the top reservoir is filled, and the bottom is empty, the level in the lower reservoir fills until the level reaches the level of the bottom of the upper reservoir. The level stays there because of atmospheric pressure. When nectar is removed the nectar is replaced by the upper reservoir until the previous fixed level is reached and atmospheric pressure stops the process. The re-design can only be used on this type hummingbird feeder. Please refer to included drawing EDSK 200718.

### CROSS-REFERENCE TO RELATED APPLICATIONS

### Not Applicable

### STATEMENT REGARDING FEDERALLY SPONSORED RES. & DEV.

### Not Applicable

### REFERENCE TO SEQUENCE LISTING, A TABLE, OR A COMPUTER CD

### Not Applicable

### BACKGROUND OF THE INVENTION

My hummingbird feeder, as described in [Para 2], is continually plagued with swarms of flying insects such as Yellow Jackets, Hornets, Wasps and Bees. When these insects are present in large numbers, the hummingbirds do not feed, and the insects rob the feeder of its nectar. Another problem is the presence of people sometimes irritates the insects resulting in painful stings. I have shopped at several local retail outlets and on the Internet for a product to remedy this problem with no results. I had considered poisons and baits on the feeder, however, I was afraid that rainwater would wash down the chemicals into the nectar and harm the hummingbirds.

I let the upper reservoir empty and in a few days, to my amazement, the flying insects stopped coming. After my examination, I discovered that the remaining nectar level in the lower reservoir had dropped so that the proboscises of the flying insects could not reach the nectar. When this happened the insects quit coming, however, the hummingbirds continued to feed for some time afterwards.

This led me to the idea of a design modification of the feeder base to lower the nectar level so the insects could not reach the nectar when the upper reservoir had reserve nectar

### SUMMARY OF THE INVENTION

Since the nectar level in the base is determined by the mating of the bottom of the upper reservoir container with the lower reservoir nectar surface, then the lower nectar level can be lowered by reducing the distance between the upper container bottom and the bottom of the base reservoir.

By research on this particular feeder the top container must be lowered approximately one fourth inch (¼″). Please refer to Drawing SKETCH 12006 included. This places the nectar level approximately five eighths inch (⅝″) below the feeding port and out of the insects' proboscises reach. This re-design idea is not restricted to this particular design feeder, but any feeder where the nectar level can be lowered out of the reach of flying insects, by base re-design as shown above.

### DESCRIPTION OF THE SEVERAL VIEWS OF THE DRAWING(S)

Drawing SKETCH 12006 is an engineering sketch showing the lower nectar level as a result of a base part modification. Drawing EDSK 200718 is an engineering sketch of a typical existing hummingbird feeder.

### DETAILED DESCRIPTION OF THE INVENTION

The purpose of this invention is to eliminate the presence of flying insects at hummingbird feeders. This causes a nuisance to people resulting in painful stings and excessive consumption of nectar by these insects, resulting in additional nectar expense. Swarms of flying insects prevent the hummingbirds from normal feeding.

These objectives are accomplished by reducing the nectar level in the feeder base to an extent that the flying insects' proboscis cannot reach the nectar. This is accomplished by lowering the position of the upper nectar reservoir relative to the base by approximately one fourth inch (¼″) which increases the distance from the feeding port flower to the nectar level to approximately five eights inch (⅝″), which is out of the reach of the flying insects' proboscis. When the flying insects can no longer feed on the nectar, they quit visiting the feeder. This modification is accomplished by changing the base plastic mold to reduce the nectar level.

This increase in the distance from the nectar level to the feeding port flower can also be accomplished by an alternate change in the base mold as described in Para 17. The base surface that supports the feeding port flower can be raised approximately one fourth inch (¼″) making the distance from the feeding port to the nectar level approximately five eighth inches (⅝″). This is out of the reach of the flying insects' proboscis and prevents their presence at the feeder.

1. This is a re-design of existing Hummingbird Feeders that have an upper nectar reservoir above a base containing the lower nectar reservoir. This eliminates the problem of the presence of flying insects such as Yellow Jackets, Hornets, Wasps and Bees. Please refer to EDSK 200718.

2. This re-design entails changing the base to reduce the distance between the bottom of the upper container and base bottom by approximately one fourth inch (¼″) and increases the distance from the feeder port to the nectar level to approximately five eighths inch (⅝″), which is outside the distance the insects' proboscis will reach and does not prevent the hummingbirds from feeding.

3. The nectar level change in claim 2 can also be accomplished by a different change in the base mold This may be accomplished by raising the mold surface that supports the feeding port flower by approximately one fourth inch (¼″), thus increasing the distance from the feeder port to the nectar level to approximately five eighths inch (⅝″), which is outside the distance the insects' proboscis will reach and does not prevent the hummingbirds from feeding.

4. This re-designed hummingbird feeder eliminates the presence of flying insects around people, that is a nuisance and may result in painful stings.

5. This re-designed hummingbird feeder eliminates the presence of flying insects, thus preventing the robbing of nectar and reduces the expense of nectar.

6. This re-designed hummingbird feeder eliminates the presence of flying insects by making simple modifications in the existing base mold.
